(19) United States
(12) Patent Application Publication
(10) Pub. No.: US 2014/0149256 A1
(43) Pub. Date: May 29, 2014

(54) ESL SYSTEM, METHOD OF CHECKING INFORMATIONS OF GOODS AND PAYING THEREFOR

(71) Applicant: SAMSUNG ELECTRO-MECHANICS CO., LTD., Gyeonggi-do (KR)

(72) Inventors: Hyu Hak KIM, Gyeonggi-do (KR); Byeong Sung Min, Gyeonngi-do (KR); Sung Ki Kim, Gyeonggi-do (KR); Kyung Choon Park, Gyeonngi-do (KR)

(73) Assignee: SAMSUNG ELECTRO-MECHANICS CO., LTD., Gyeonggi-do (KR)

(21) Appl. No.: 13/688,110

(22) Filed: Nov. 28, 2012

(51) Int. Cl. G06Q 30/06

(52) U.S. Cl. CPC G06Q 30/0623
USPC 705/26.61

(57) ABSTRACT

Disclosed herein is an electronic shelf label (ESL) system. The ESL system includes a main server; a client server transmitting or receiving information of goods stored in the main server through a communications network; and an electronic tag transmitting or receiving the information of goods to/from the client server through a sink node, wherein the electronic tag includes: a storage unit storing the information of goods received from the client server; an identification unit identifying goods corresponding to the information of goods; and a short-distance communication module.

### CROSS REFERENCE(S) TO RELATED APPLICATIONS

This application claims the benefit under 35 U.S.C. Section 119 of Korean Patent Application Serial No. 10-2011-0126984, entitled “ESL System, and Method of Checking Information of Goods and Paying Therefor” filed on Nov. 30, 2011, which is hereby incorporated by reference in its entirety into this application.

### BACKGROUND OF THE INVENTION

1. Technical Field

The present invention relates to an electronic shelf label (ESL) system, and more particularly, to an ESL system where information of goods is delivered to an electronic tag or an electronic shelf end device through a communication network of the ESL system by combining a near field communication(NFC) chip of a short-distance communication and an electronic shelf label(ESL), and where a customer may receive information of goods with a handheld mobile communication end device using short-distance communication and checking information of goods, checking payment information, financial settlement and the like are possible through a TCP/IP network or a mobile network.

2. Description of the Related Art

An electronic shelf label(ESL) system configuration according to the related art includes a main management server, a client server, and an electronic tag (or an electronic shelf end device). The main management server is located outside the store, and the client server and the electronic tag are located inside the store.

The main management server includes a database for information of goods inside a store, the information of goods inside the store is stored in the client server by a method of being delivered to the client server inside a store by a TCP/IP network communication through a wired/wireless LAN.

The information of goods stored in the client server is transmitted or received, in a wired/wireless type, to/from the electronic tag inside a store through a sink node inside the store. The sink node is a wired/wireless transceiver sharing information of goods inside a store, and transmitting or receiving the shared information of goods to/from the electronic tag installed inside a store. The electronic tag means an electronic shelf end device.

With the ESL system according to the related art, information of goods may be exactly delivered but information of many goods may not be simultaneously output to an electronic tag or a tag display due to a limited display circumstance, thereby leading to a problem that since only limited information of goods, such as price, name, unit price, amount, origin, and the like, of goods, is displayed to customers, the customers are not able to know various and detailed items on information of goods.

### SUMMARY OF THE INVENTION

An object of the present invention is to enable checking of detailed information of goods, checking of purchase information, and performing on-line financial approval by applying a short distance communication and a mobile communication to an ESL system according to the related art.

According to an exemplary embodiment of the present invention, there is provided an electronic shelf label (ESL) system, including: a main server; a client server transmitting or receiving information of goods stored in the main server through a communications network; and an electronic tag transmitting or receiving the information of goods to/from the client server through a sink node, wherein the electronic tag includes: a storage unit storing the information of goods received from the client server; an identification unit identifying goods corresponding to the information of goods; and a short-distance communication module.

The ESL system may further include a mobile communication end device including: a recognition unit recognizing goods through the identification unit; a storage unit storing the information of goods; a display unit displaying the information of goods recognized by the recognition unit to a user; a communication unit receiving the information of goods from the electronic tag and the short-distance communication module, and transmitting or receiving information of payment for the goods; and a control unit controlling transmission or reception of the information of goods and the information of payment for the goods

The identification unit may be a bar code, a RFID, or a QR code, and the recognition unit may be a bar code scanner, a RFID reader, or a camera.

The communications network may be a TCP/IP network through a wired/wireless LAN.

The short-distance communication module may be a near field communication(NFC) chip.

The ESL system may further include a short-distance communication network in which the short distance communication module transmits or receives information to/from the communications network.

The ESL system may further include a mobile communication network in which the mobile communication end device transmits or receives information to/from the communications network.

According to another exemplary embodiment of the present invention, there is provided a method for checking information of goods, including: recognizing, by a mobile communication end device including a short-distance communication module, an identification label of goods displayed on an electronic tag; requiring, by the mobile communication end device, a display of information of goods from a main server or a client server through a short-distance communication network; transmitting, by the main server or the client server, the information of goods to the mobile communication end device through the short-distance communication network; and outputting, by the mobile communication end device, the information of goods.

According to another exemplary embodiment of the present invention, there is provided a method for paying for goods, including: recognizing, by a mobile communication end device including a short-distance communication module, an identification label of goods displayed on an electronic tag; requiring, by the mobile communication end device, a display of information of goods from a main server or a client server through a short-distance communication network; transmitting, by the main server or the client server, the information of goods to the mobile communication end device through a short-distance communication network; outputting, by the mobile communication end device, the information of goods; performing, by a user, payment for the goods after checking the information of goods; and approving, by the main server or the client server, the payment for goods.

The performing of the payment and the approving of the payment for the goods may be executed through the short-distance communication network or a mobile network.

### BRIEF DESCRIPTION OF THE DRAWINGS

FIG. 1 is a conceptual diagram of an ESL system according to an exemplary embodiment of the present invention;

FIG. 2 is a block diagram of a mobile communication end device according to an exemplary embodiment of the present invention;

FIG. 3 is a block diagram of the ESL system according to an exemplary embodiment of the present invention; and

FIG. 4 is a flowchart of a method for checking information of goods and a method for paying for goods according to an exemplary embodiment of the present invention.

### DESCRIPTION OF THE PREFERRED EMBODIMENTS

Hereinafter, exemplary embodiments of the present invention will be described in detail with reference to the accompanying drawings. However, this is only by way of example and therefore, the present invention is not limited thereto.

When technical configurations known in the related art are considered to make the contents obscure in the present invention, the detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

Hereinafter, the present invention will be described with reference to the accompanying drawings.

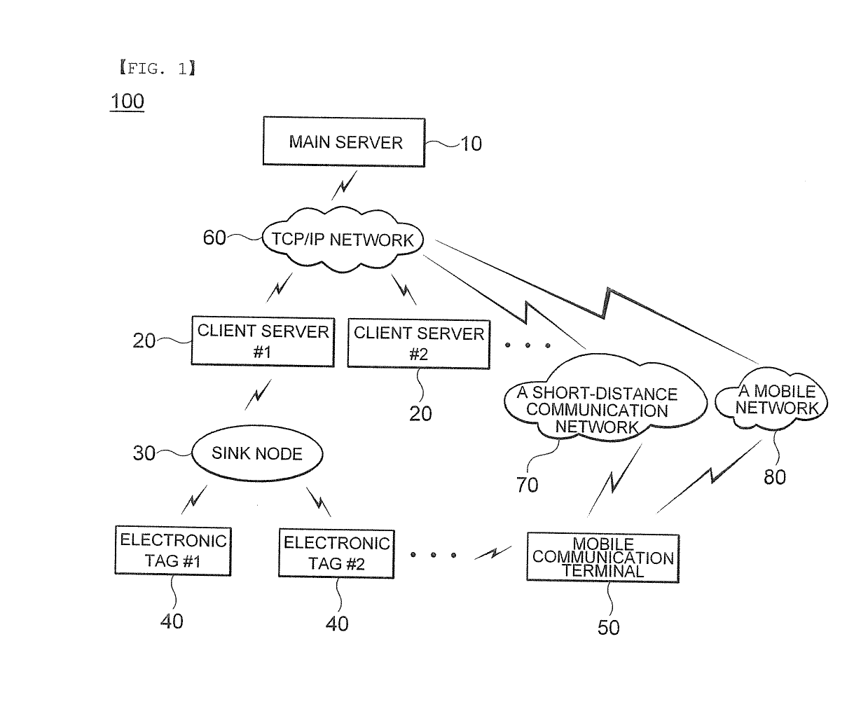

FIG. 1 is a conceptual diagram of an ESL system according to an exemplary embodiment of the present invention.

Referring to FIG. 1, an electronic shelf label (ESL) system 100 includes a main server 10, a client server 20 transmitting or receiving information of goods stored in the main server 10 through a communications network 60, and an electronic tag 40 transmitting or receiving the information of goods to/from the client server 20 through a sink node 30. The electronic tag 40 may include a storage unit (not shown) storing the information of goods received from the client server 20, an identification unit (not shown) identifying goods corresponding to the information of goods, and a short-distance communication module (not shown).

The information of goods may be price, name, usage, quantity, origin, advertisement, or the like, of goods, and the information of goods may be a recipe, ingredients, or the like, if the goods are food.

The sink node 30 may be a wired/wireless device transmitting information of goods inside a store to the electronic tag 40 installed inside the store.

The electronic tag 40 may be used as a tag for displaying information of corresponding goods by being attached to a shelf or a display stand of goods. Moreover, the electronic tag 40 may be integratedly managed or updated by the main server 10 of the client server 20 by electronically operating through the sink node 30.

The electronic tag 40 may include an identification unit identifying goods corresponding to the information of goods. In this case, the identification unit may be a bar code, a RFID or a QR code.

The communications network 60 may be a TCP/IP network through a wired/wireless LAN, and the short-distance communication module may be a near field communication (NFC) chip.

In this case, the ESL system may further include a short-distance communication network 70 in which the short-distance communication module transmits or receives information to/from the communications network 60. The short-distance communication network 70 may transmit the information of goods to the mobile communication end device 50.

In addition, the ESL system may further a mobile communication network 80 in which the mobile communication end device 50 transmits or receives information to/from the communications network 60. The information of goods may be checked, and purchase and payment for the goods may be performed after the information of goods is checked, by the mobile communication end device 50, through the mobile communication network 80.

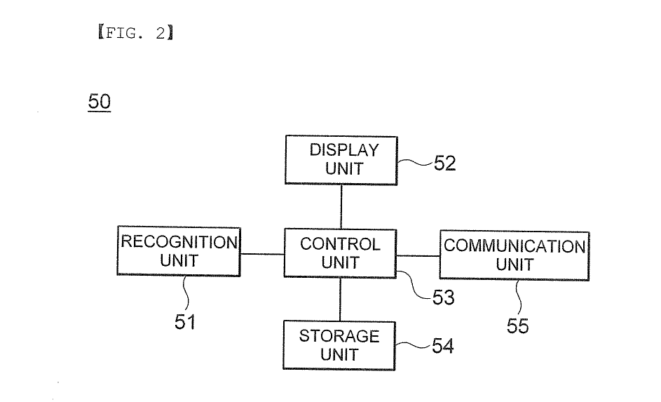

FIG. 2 is a block diagram of a mobile communication end device according to an exemplary embodiment of the present invention.

Referring to FIG. 2, the ESL system according to an exemplary embodiment of the present invention may further include a mobile communication end device 50 including: a recognition unit 51 recognizing goods through the identification unit, a storage unit 54 storing information of goods, a display unit 52 displaying the information of goods recognized by the recognition unit 51 to a user, a communication unit 55 receiving the information of goods from the electronic tag 40 and the short-distance communication module and transmitting or receiving information of payment for goods, and a control unit 53 controlling transmission or reception of the information of goods and the information of payment for goods.

A user may recognize the information of goods under a control of the control unit 53 by locating the recognition unit 51 close to the electronic tag 40. The information of goods recognized may be stored in the storage unit 54 and displayed to a user through the display unit 52.

The storage unit 54 may be a memory, and the display unit 52 may be a display of the mobile communication end device 50.

In this case, the recognition unit 51 may be a bar code scanner, a RFID reader, or a camera.

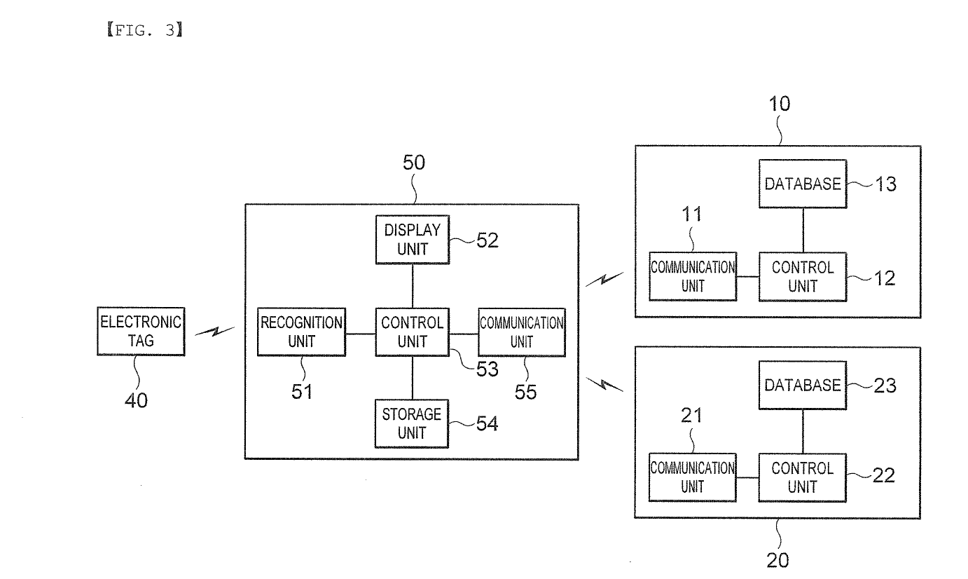

FIG. 3 is a block diagram of the ESL system according to an exemplary embodiment of the present invention.

Referring to FIG. 3, the ESL system according to an exemplary embodiment of the present invention may be configured of the electronic tag 40, the mobile communication end device 50, and communication between servers. In this case, the server may be the main server 10 or the client server 20, and the server may include communication units 11 and 21, control units 12 and 22, and databases 13 and 23.

The recognition unit 51 may recognize the information of goods under a control of the control unit 53 by being located close to the electronic tag 40, and a user may check the information of goods through the display unit 52.

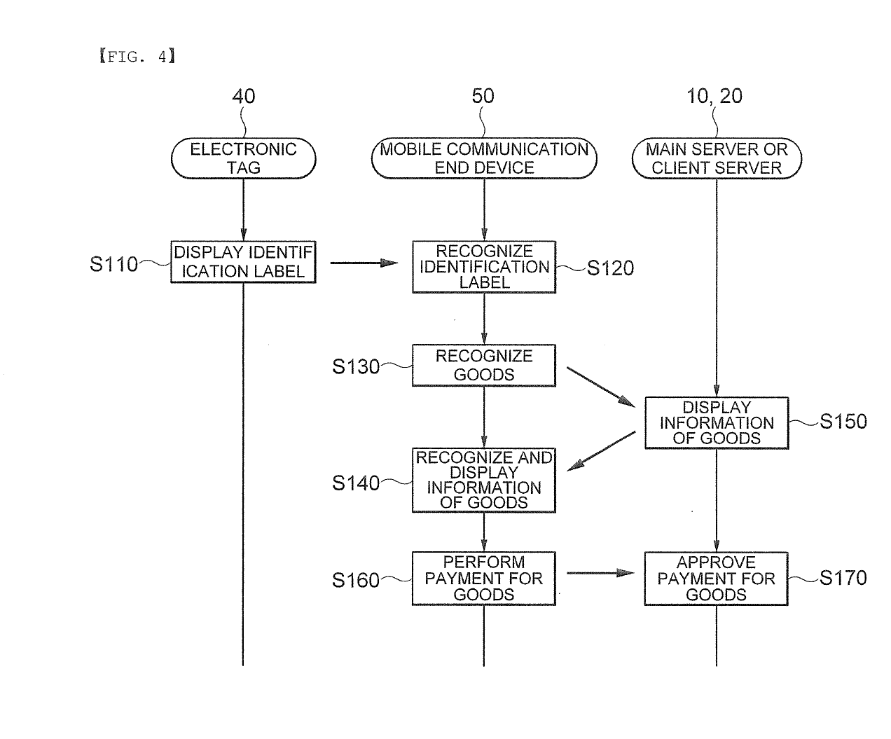

FIG. 4 is a flowchart of a method of checking information of goods and paying for goods according to an exemplary embodiment of the present invention.

Referring to FIG. 4, a method of checking information of goods according to an exemplary embodiment of the present invention may include: recognizing, by a mobile communication end device including a short-distance communication module, an identification label of goods displayed on an electronic tag (S120); requiring, by the mobile communication end device, a display of information of goods from a main server or a client server through a short-distance communication network (S130); transmitting, by the main server or the client server, the information of goods to the mobile communication end device through the short-distance communication network (S150); and outputting, by the mobile communication end device, the information of goods (S140).

The method may further include displaying, by the mobile communication end user including the short distance communication module, an identification label of goods with an electronic tag (S110) before the recognizing of the identification label of goods displayed on the electronic tag (S120).

A method of paying for goods according to an exemplary embodiment of the present invention may include: recognizing, by a mobile communication end device including a short-distance communication module, an identification label of goods displayed on an electronic tag (S120); requiring, by the mobile communication end device, a display of information of goods from a main server or a client server through a short-distance communication network (S130); transmitting, by the main server or the client server, the information of goods to the mobile communication end device through a short-distance communication network (S150); outputting, by the mobile communication end device, the information of goods (S140); performing, by a user, payment for the goods after checking the information of goods (S160); and approving, by the main server or the client server, the payment for the goods (S170).

The method may further include displaying an identification label of goods with an electronic tag (S110), before the recognizing, by the mobile communication end device including a short-distance communication module, of the identification label of goods displayed on the electronic tag (S120).

The performing of the payment (S160) and the approving of the payment for the goods (S170) may be executed through the short-distance communication network or a mobile network.

As set forth above, according to the exemplary embodiment of the present invention, customers may recognize various and exact information of goods in real-time, thereby making it possible to easily comprehend more detailed information of goods, and store managers may easily and rapidly deliver a lot of information to the customers, thereby making it possible to perform an efficient store management.

In addition, a short-distance communication network or a mobile network is used, whereby an immediate payment of goods on on-line may be performed by a mobile communication end device of a user.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. An electronic shelf label (ESL) system, comprising:
a main server;
a client server transmitting or receiving information of goods stored in the main server through a communications network; and
an electronic tag transmitting or receiving the information of goods to/from the client server through a sink node,
wherein the electronic tag includes:
a storage unit storing the information of goods received from the client server;
an identification unit identifying goods corresponding to the information of goods; and
a short-distance communication module.

2. The ESL system according to claim 1, further comprising a mobile communication end device including:
a recognition unit recognizing goods through the identification unit;
a storage unit storing the information of goods;
a display unit displaying the information of goods recognized by the recognition unit to a user;
a communication unit receiving the information of goods from the electronic tag and the short-distance communication module, and transmitting or receiving information of payment for the goods; and
a control unit controlling transmission or reception of the information of goods and the information of payment for the goods.

3. The ESL system according to claim 2, wherein the identification unit is a bar code, a RFID, or a QR code, and the recognition unit is a bar code scanner, a RFID reader, or a camera.

4. The ESL system according to claim 1, wherein the communications network is a TCP/IP network through a wired/wireless LAN.

5. The ESL system according to claim 1, wherein the short-distance communication module is a near field communication(NFC) chip.

6. The ESL system according to claim 1, further comprising a short-distance communication network in which the short distance communication module transmits or receives information to/from the communications network.

7. The ESL system according to claim 1, further comprising a mobile communication network in which the mobile communication end device transmits or receives information to/from the communications network.

8. A method for checking information of goods, comprising:
recognizing, by a mobile communication end device including a short-distance communication module, an identification label of goods displayed on an electronic tag;
requiring, by the mobile communication end device, a display of information of goods from a main server or a client server through a short-distance communication network;
transmitting, by the main server or the client server, the information of goods to the mobile communication end device through the short-distance communication network; and
outputting, by the mobile communication end device, the information of goods.

9. A method for paying for goods, comprising:
recognizing, by a mobile communication end device including a short-distance communication module, an identification label of goods displayed on an electronic tag;
requiring, by the mobile communication end device, a display of information of goods from a main server or a client server through a short-distance communication network;
transmitting, by the main server or the client server, the information of goods to the mobile communication end device through a short-distance communication network;
outputting, by the mobile communication end device, the information of goods;
performing, by a user, payment for the goods after checking the information of goods; and
approving, by the main server or the client server, the payment for goods.

10. The method according to claim 9, wherein the performing of the payment and the approving of the payment for the goods are executed through the short-distance communication network or a mobile network.
